(19) United States
(12) Patent Application Publication
(10) Pub. No.: US 2023/0272639 A1
(43) Pub. Date: Aug. 31, 2023

(54) SOLAR OUTDOOR WARM TENT

(71) Applicant: SHENZHEN YINGSHIKANG TECHNOLOGY LTD, Shenzhen, Guangdong (CN)

(72) Inventors: Qiang Guo, Shenzhen, Guangdong (CN); Yiming Wang, Shenzhen, Guangdong (CN); Jeffrey Roger Myers, Shenzhen, Guangdong (CN); Peter Bladd Symms, Shenzhen, Guangdong (CN)

(21) Appl. No.: 17/436,618

(22) PCT Filed: May 27, 2021
(86) PCT No.: PCT/CN2021/096530

§ 371 Date: Sep. 6, 2021

(30) Foreign Application Priority Data
Apr. 15, 2021 (CN) 202120780299.2

(51) Int. Cl. E04H 15/12; H02S 20/22; E04H 15/54

(52) U.S. Cl. CPC E04H 15/12; H02S 20/22; E04H 15/54

(57) ABSTRACT

The present disclosure relates to a solar outdoor warm tent. The tent comprises a bottom plate and an upper cover, wherein the upper cover is closed on the bottom plate and an activity space is enclosed between them, the upper cover and the bottom plate are both made of composite plate materials, and the composite plate material comprises a foamed polypropylene layer in the middle and self-reinforced polypropylene layers on two sides. In the present disclosure, the self-reinforced polypropylene layers are composited on the two sides of the foamed polypropylene layer respectively, and due to the super impact resistance and high rigidity of the self-reinforced polypropylene layers, the body of the tent is not easy to be scratched, punctured or broken, so the tent is not easy to wear, thus improving the protection capability of the tent itself, such as preventing being attacked and bitten by wild animals, so that the tent can be used in a harsher wild environment to ensure the safety of a user, which also meet the needs of the user. In addition, the weight of the composite plate material is relatively light, and it may float on the water for a short time in the event of a flood, which further improves the safety. Due to a good thermal insulation performance of the composite plate material, it is possible to provide a thermal insulation performance to a certain degree, thus being more suitable for use in the wild.

### TECHNICAL FIELD

The present disclosure relates to outdoor goods, and more specifically to a solar outdoor warm tent.

### BACKGROUND ART

Tents are movable buildings that are propped on the ground to shelter from wind, rain, and sunlight, and for temporary residence. Conventional tents are mostly made of canvas, which can be removed, and transferred at any time together with supporting things. The skeleton of a tent is composed of tent poles and is fixed by guy lines. The skeleton is covered with a flysheet, which can be used to block the line of sight and shelter from wind and rain. Tents can be easily erected, dismantled and transported. Some tents are not fixed and are tied directly in the wild, while others are tied to piles on the ground. Initially, tents were used by nomads, but now tents are mainly used for camping. Modern tents require non-flammable materials for the tent fabric. The protection capability of a tent in the prior art is relatively deficient, and the tent itself is easy to be scratched, punctured and broken, which needs to be improved.

### SUMMARY

The purpose of the present disclosure is to overcome the above shortcomings of the prior art and provide a solar outdoor warm tent to improve its protection capability.

To achieve the above-mentioned purpose, the technical solution used by the present disclosure is as follows: a solar outdoor warm tent, comprising a bottom plate and an upper cover, wherein the upper cover is closed on the bottom plate and an activity space is enclosed between them, the upper cover and the bottom plate are both made of composite plate materials, and the composite plate material comprises a foamed polypropylene layer in the middle and self-reinforced polypropylene layers composited on two sides.

There is also provided with a fireproof polypropylene layer between the foamed polypropylene layer and the self-reinforced polypropylene layer on the outside.

A flexible photovoltaic panel is laid on the outer surface of the upper cover and is connected to at least one energy storage battery through a photovoltaic inverter, and the energy storage battery is used to store electrical energy generated by the flexible photovoltaic panel.

Accommodation cavities are provided in the bottom plate and the accommodation cavities are provided with openings on the side of the bottom plate, the energy storage battery is inserted into the accommodation cavity from a side opening of the bottom plate to be fixedly placed, the accommodation cavity is provided with a metal joint for electrically connecting the energy storage battery and the photovoltaic inverter.

A flexible heating sheet is attached to the inner surface of the upper cover, the flexible heating sheet is used to heat the air in the activity space, and the flexible heating sheet is electrically connected to the energy storage battery.

The upper cover is internally provided with an illuminating light board, and the illuminating light board is electrically connected to the energy storage battery.

A charging interface is provided in the tent, and the charging interface is electrically connected to the energy storage battery.

An SOS distress locator is provided on the outer side of the upper cover, and the SOS distress locator is electrically connected to the energy storage battery.

There is also a biodegradable toilet in the tent.

The tent also comprises a foldable side fence, the side fence is made of the composite plate material; the side fence is used to cover a side end opening of the upper cover, an edge of the side fence is provided with several tabs, and the side fence is engaged with the side end opening of the upper cover in snap fit through the tabs; and an outer edge of the side fence is also provided with a side mesh for preventing mosquitoes, and the side mesh is attached to the inner wall of the side end opening of the upper cover through Velcro.

Compared with the prior art, the present disclosure has the following beneficial effects: the self-reinforced polypropylene layers are composited on the two sides of the foamed polypropylene layer respectively, and due to the super impact resistance and high rigidity of the self-reinforced polypropylene layers, the body of the tent is not easy to be scratched, punctured or broken, so the tent is not easy to wear, thus improving the protection capability of the tent itself, so that the tent can be used in a harsher wild environment, such as preventing, being attacked and bitten by wild animals, to ensure the safety of a user, which also meet the needs of the user. In addition, the weight of the composite plate material is relatively light, and it may float on the water for a short time in the event of a flood, which further improves the safety. Due to a good thermal insulation performance of the composite plate material, it is possible to provide a thermal insulation performance to a certain degree, thus being more suitable for use in the wild. In addition, the SOS distress locator carried by the tent may make the user feel safer in the wild, and can give a timely feedback and receive a timely rescue in the event of an emergency.

The above description is merely an overview of the technical solution of the present disclosure. In order to understand the technical means of the present disclosure more clearly, it can be implemented in accordance with the content of the specification, and in order to make the above and other purposes, features and advantages of the present disclosure more obvious and easier to understand, preferred embodiments are specifically cited below, which are described in detail as follows.

### BRIEF DESCRIPTION OF THE DRAWINGS

FIG. 1 is a three-dimensional view of a tent of the present disclosure.

FIG. 2 is a cross-sectional view of a tent of the present disclosure.

FIG. 3 is a cross-sectional view of a composite plate material of the present disclosure.

FIG. 4 is a front view of a side fence of the present disclosure.

### DETAILED DESCRIPTION OF EMBODIMENTS

In order to make the purpose, technical solutions and advantages of the present disclosure clearer, the present disclosure will be further described in detail below with reference to the accompanying drawings and specific embodiments.

The technical solutions in the embodiments of the present disclosure will be clearly and completely described below in conjunction with the accompanying drawings of the embodiments of the present disclosure; and obviously, the embodiments described are merely some, rather than all, of the embodiments of the present disclosure. All other embodiments obtained by those skilled in the art based on the embodiments of the present disclosure without any creative effort shall fall within the protection scope of the present disclosure.

In the description of the present disclosure, it should be understood that the orientation or positional relationship indicated by terms “center”, “longitudinal”, “transverse”, “length”, “width”, “thickness”, “upper”, “lower”, “front”, “rear”, “left”, “right”, “vertical”, “horizontal”, “top”, “bottom”, “inside”, “outside”, “clockwise”, “counterclockwise” and the like is based on the orientation or positional relationship shown in the drawings, which is merely for the convenience of describing the present disclosure and for the simplification of the description, and not to indicate or imply that the means or element referred to must have a specific orientation, be constructed and operated in a specific orientation. Therefore, the above terms shall not be construed as a limitation of the present disclosure.

In the present disclosure, unless otherwise clearly specified and defined, the terms “mounted”, “connecting”, “connected”, “fixed” and other terms should be understood in a broad sense. For example, it may be a connection and may also be a detachable connection or integrated connection; may be a mechanical connection and may also be an electrical connection; and may be a direct connection and may also be an indirect connection through an intermediate medium, and may be communication between interiors of two elements or interaction relationship between two elements. For those of ordinary skills in the art, the specific meaning of the above-mentioned terms in the present disclosure should be construed according to specific circumstances.

In the present disclosure, unless otherwise clearly specified and defined, a first feature is “above” or “below” a second feature may include that the first and second features are in direct contact, or may include that the first and second features are not in direct contact but are in contact with another feature between them. Moreover, the first feature is “above”, “over” or “on” the second feature includes that the first feature is directly above or obliquely above the second feature, or it simply indicates that the first feature is higher in horizontal height than the second feature. The first feature is “below”, “under” or “underneath” the second feature includes that the first feature is directly below or obliquely below the second feature, or it simply indicates that the first feature is lower in horizontal height than the second feature.

In the description of this specification, descriptions with reference to terms “one embodiment”, “some embodiments”, “an example”, “a specific example”, or “some examples” etc., mean specific features, structures, materials or characteristics described in conjunction with the embodiment(s) or example(s) are included in at least one embodiment or example of the present disclosure. In this specification, the schematic representation of the above-mentioned terms should not be constructed as necessarily referring to the same embodiment or example. Moreover, the described specific features, structures, materials, or characteristics may be combined in any one or more embodiments or examples in a suitable manner. In addition, those skilled in the art may combine different embodiments or examples described in this specification.

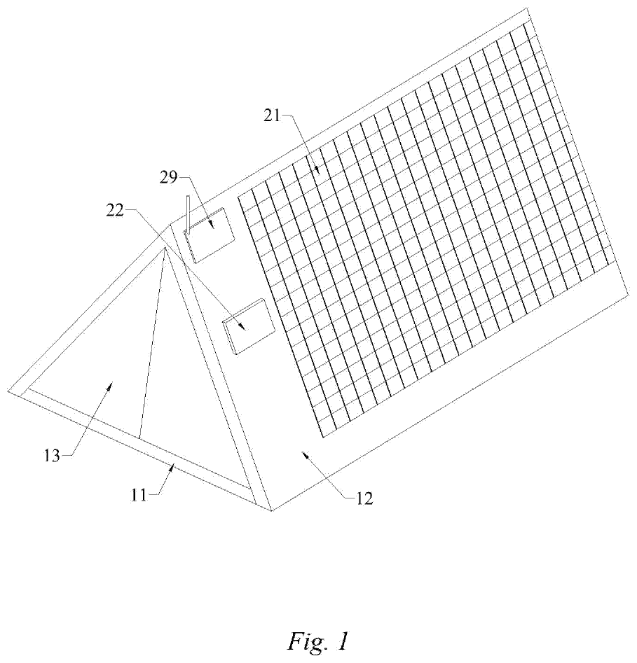

This embodiment is a solar outdoor warm tent, and its specific structure is shown in FIGS. 1 to 4.

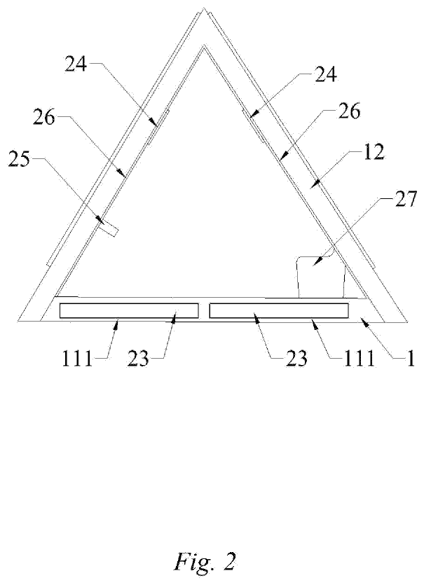

As shown in FIG. 1, the tent comprises a bottom plate 11 and an upper cover 12. The upper cover 12 is closed on the bottom plate 11, and an activity space is enclosed between them. In this embodiment, the upper cover 12 is triangular, and in other embodiments, the upper cover may also be made into a square shape, a cylindrical shape, or the like. A flexible photovoltaic panel 21 that uses solar energy to generate electricity is laid on the outer surface of the upper cover 12. The flexible photovoltaic panel 21 is connected to at least one energy storage battery 23 (shown in FIG. 2) through a photovoltaic inverter 22. The energy storage battery 23 is used to store electric energy generated by the flexible photovoltaic panel 21. As shown in FIG. 2, accommodation cavities 111 are provided in the bottom plate 11 and the accommodation cavities 111 are provided with openings on the side of the bottom plate 11. The energy storage battery 23 is inserted into the accommodation cavity 111 from a side opening of the bottom plate 11 to be fixedly placed. The accommodation cavity 111 is provided with a metal joint (not shown) for electrically connecting the energy storage battery 23 and the photovoltaic inverter 22. In implementation, more than one energy storage battery 23 may be provided. For example, two energy storage batteries 23 are accommodated on each of both sides of the bottom plate 11 respectively, with a total of four energy storage batteries 23, which can increase the energy storage capacity and allow a user to have more electric power to use in the wild. In addition, a sealing cover plate may be provided at the opening of the accommodation cavity 111 to achieve an effect of dustproof and waterproof.

In addition, as shown in FIG. 1, an SOS distress locator 29 is provided on the outer side of the upper cover 12, and the SOS distress locator 29 is electrically connected to the energy storage battery 23. The use of the SOS distress locator 29 can make the user feel safer in the wild, and can give a timely feedback and receive a timely rescue in the event of an emergency.

In addition, as shown in FIG. 2, a flexible heating sheet 26 electrically connected to the energy storage battery 23 is attached to the inner surface of the upper cover 12. The flexible heating sheet 26 is used to heat the air in the activity space of the tent, especially when the temperature is low at night, to keep the tent in a suitable temperature range, which is beneficial to ensure the health of the user.

In addition, as shown in FIG. 2, the upper cover 12 is internally provided with an illuminating light board 24 electrically connected to the energy storage battery 23 and a charging interface 25 electrically connected to the energy storage battery 23. The charging interface 25 can be a vehicle-mounted charging interface, which is convenient for the user to put a vehicle-mounted electrical appliance in the tent for use. In addition, there is also provided with a biodegradable toilet 27 in the tent.

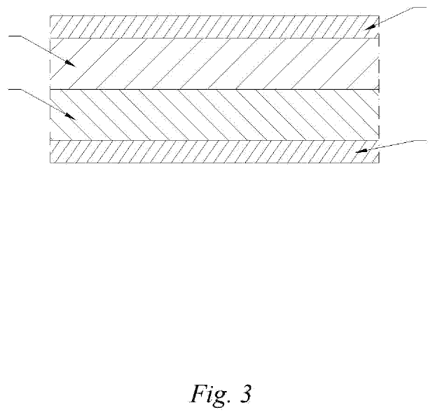

Both the upper cover 12 and the bottom plate 11 in FIGS. 1 and 2 are made of composite plate materials. As shown in FIG. 3, the composite plate material comprises a foamed polypropylene layer 31 in the middle, and a self-reinforced polypropylene layer 32 and a self-reinforced polypropylene layer 33 composited on two sides. The number of layers of the self-reinforced polypropylene layer 32 and the self-reinforced polypropylene layer 33 on the two sides ranges from 4 to 6. The self-reinforced polypropylene layer 32 and the self-reinforced polypropylene layer 33 are composited on the foamed polypropylene layer 31 through a hot pressing process. In addition, there is also provided with a fireproof polypropylene layer 34 between the foamed polypropylene layer 31 and the self-reinforced polypropylene layer 32 on the outside of the tent, which may improve the fireproof ability of the tent and further enhance its protection capability.

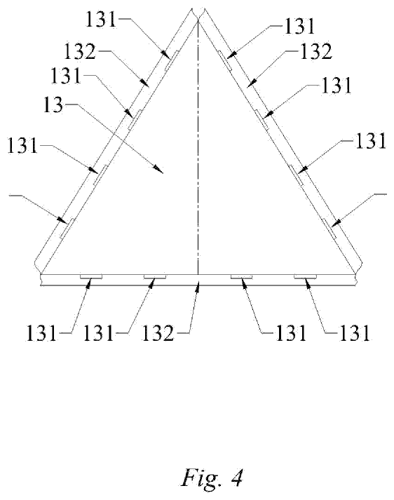

In addition, as shown in FIG. 1, the tent also comprises a foldable side fence 13. The side fence 13 is also made of the composite plate material of this embodiment. The side fence 13 is used to cover a side end opening of the upper cover 12. As shown in FIG. 4, each edge of the side fence 13 is provided with several tabs 131. The side fence 13 is engaged with the side end opening of the upper cover 12 in snap fit through these tabs 131. Each outer edge of the side fence 13 is also provided with a side mesh 132 for preventing mosquitoes. The side mesh 132 is attached to the inner wall of the side end opening of the upper cover 12 through Velcro, so the side mesh 132 may not only prevent mosquitoes but also ensure the ventilation of the activity space in the tent.

In this embodiment, for the upper cover 12 and the bottom plate 11 of the tent, the self-reinforced polypropylene layers 32 and 33 are composited on the two sides of the foamed polypropylene layer 31 respectively, and due to the super impact resistance and high rigidity of the self-reinforced polypropylene layers 32 and 33, the upper cover 12 and the bottom plate 11 are not easy to be scratched, punctured or broken, so the tent is not easy to wear. The protection capability of the tent itself is improved, so that the tent can be used in a harsher outdoor environment, to ensure the safety of the user, and also meet the needs of the user. Moreover, the self-reinforced polypropylene layers 32 and 33 can also be used normally at low temperatures, thus ensuring the normal protection capability of the tent in a low temperature environment in the wild.

The above only uses embodiments to further illustrate the technical content of the present disclosure, so as to make it easier for readers to understand, but it does not mean that the implementation of the present disclosure is limited to this. Any technical extension or re-creation made in accordance with the present disclosure is all protected by the present disclosure. The scope of protection of the present disclosure is defined the claims.

1. A solar outdoor warm tent, comprising a bottom plate and an upper cover, wherein the upper cover is closed on the bottom plate and an activity space is enclosed between them, the upper cover and the bottom plate are both made of composite plate materials, and the composite plate material comprises a foamed polypropylene layer in the middle and self-reinforced polypropylene layers composited on two sides.

2. The solar outdoor warm tent of claim 1, wherein there is also provided with a fireproof polypropylene layer between the foamed polypropylene layer and the self-reinforced polypropylene layer on the outside.

3. The solar outdoor warm tent of claim 1, wherein a flexible photovoltaic panel is laid on the outer surface of the upper cover and is connected to at least one energy storage battery through a photovoltaic inverter, and the energy storage battery is used to store electrical energy generated by the flexible photovoltaic panel.

4. The solar outdoor warm tent of claim 3, wherein accommodation cavities are provided in the bottom plate and the accommodation cavities are provided with openings on the side of the bottom plate, the energy storage battery is inserted into the accommodation cavity from a side opening of the bottom plate to be fixedly placed, and the accommodation cavity is provided with a metal joint for electrically connecting the energy storage battery and the photovoltaic inverter.

5. The solar outdoor warm tent of claim 3, wherein a flexible heating sheet is attached to the inner surface of the upper cover, the flexible heating sheet is used to heat the air in the activity space, and the flexible heating sheet is electrically connected to the energy storage battery.

6. The solar outdoor warm tent of claim 3, wherein the upper cover is internally provided with an illuminating light board, and the illuminating light board is electrically connected to the energy storage battery.

7. The solar outdoor warm tent of claim 3, wherein a charging interface is provided in the tent, and the charging interface is electrically connected to the energy storage battery.

8. The solar outdoor warm tent of claim 3, wherein an SOS distress locator is provided on the outer side of the upper cover, and the SOS distress locator is electrically connected to the energy storage battery.

9. The solar outdoor warm tent of claim 1, wherein there is also provided with a biodegradable toilet in the tent.

10. The solar outdoor warm tent of claim, 1, wherein the tent also comprises a foldable side fence, the side fence is made of the composite plate material; the side fence is used to cover a side end opening of the upper cover, an edge of the side fence is provided with several tabs, and the side fence is engaged with the side end opening of the upper cover in snap fit through the tabs; and an outer edge of the side fence is also provided with a side mesh for preventing mosquitoes, and the side mesh is attached to the inner wall of the side end opening of the upper cover through Velcro.
